(19) United States
(12) Patent Application Publication
(10) Pub. No.: US 2006/0129717 A1
(43) Pub. Date: Jun. 15, 2006

(54) Queue change control with remote user interaction and notification

(75) Inventors: Michael A. Farrell, Ontario, NY (US); Javier A. Morales, Rochester, NY (US)

Correspondence Address: ORTIZ & LOPEZ, PLLC;Patent Attorneys, P.O. Box 4484, Albuquerque, NM, 87196-4484, US

(73) Assignee: Xerox Corporation

(21) Appl. No.: 11/009,652

(22) Filed: Dec. 10, 2004

(51) Int. Cl. G06F 5/00

(52) U.S. Cl. 710/54

(57) ABSTRACT

Print jobs are typically created as a combination of a document to be printed and the resources required for printing. A queue, or functionally similar construct, specifies the required resources and how they will be used. Users must be alerted to queue changes to avoid undesired results. Additionally, requiring an approval process such as voting can limit inappropriate queue changes. Included are elements for alerting users and voting on queue changes.

### TECHNICAL FIELD

The present embodiments pertain to managing workflow information in a production environment. Specifically the embodiments pertain to managing printing work flows and informing users when a printing work flow has changed.

### BACKGROUND

In automated manufacturing systems, there are a number of elements required for producing a product from a design. In the field of printing, the desired product is a publication, such as a book. In printing, the design is typically an electronic version of the publication, called a document here for want of a better term. In order to get the publication, a user specifies the document, the resources to use, and how to use the resources. For example, one simple desktop printing task would require the user to specify the document and the resources would simply be the printer attached to the user's computer. A slightly more complicated task would require the user to specify the document and a network printer, which is a printer the computer may reach via a computer network. In a complicated example, a user has a document that must be printed on an offset press. In this case, the resources can include the types of paper, ink, and the press itself. The process of producing the publication can include tasks such as preflight, imposition, watermarking, printing, and joining. In this more complicated case, the user can create a print job by combining the document and a specification of what tasks and materials are required to produce the desired document.

The art involves ways that a user can specify the materials and tasks required to produce a publication from a document. Here, the specification of materials and tasks is called a queue. The queue is a precise specification of what tasks must be performed, how each task must be performed, the order of the tasks, and what materials are required for each task. It is convenient for a queue to be created once, and then used many times by many users. It is also advantageous for a queue to be created by an expert. A user creates a print job by choosing a document and choosing a queue. A publication is produced when a user submits a print job and the print job is performed.

The art refers to queues by a variety of names including queues, hot folders, virtual printers, and work flows. Regardless of the term used in the prior art, the functionality is the same and suffers from a major limitation. Queues can be changed without alerting users or other interested parties. Queues can be changed between the time the user creates the print job and the job is performed. Users can submit print jobs using a queue that worked well in the past, but which has since been changed without the user's knowledge. Not knowing the queue is changed; users can get an unintended result from their print jobs. The result is unhappy users, discarded publications, and waste.

Another problem with current art is that a single person can change a queue without involving anyone else in the decision. Sometimes, a single user making changes is appropriate. However, in a facility where a number of people depend on each queue to work predictably, a single person making changes can have unfavorable results. A more extreme case is in a volume printing situation where an approved change can result in the improper execution of large expensive print jobs. This is similar to any other manufacturing process wherein every change is reviewed before it is accepted or rejected. Reviewing changes before accepting or rejecting them often saves money and more often avoids wasting money.

The present embodiments overcome the aforementioned limitations and flaws of the prior art.

### BRIEF SUMMARY OF THE EMBODIMENTS

The present embodiments address limitations and flaws in the prior art by keeping people informed of changes to queues and, in certain aspects, using a change approval process.

Users of a queue often want to know that a queue changed. The embodiments associate a subscriber list with each queue. A subscriber list is a list of the people, subscribers, who would care if a queue changed. Generally, those are people who have used the queue, are expected to use the queue, or have some responsibility for the printing resources a queue would cause to be used. The information given to the subscribers can vary. They could be simply told the queue changed. They could also be told what was changed. Finally, they could also receive recommendations of other queues that may better suit their needs than the changed one.

Another feature addresses when to tell the subscribers about the change. In one aspect, the subscribers are alerted as soon as the change occurs. In another aspect, they are not alerted until they actually try to use the queue.

The embodiments also enable association of a list of voters with the queue who vote to approve or reject a queue change request. This helps ensure that queue changes are carefully considered before being made. Another feature provides for limiting the amount of time for a queue change request to be approved. Further aspects of the embodiments include a list of monitors that can be associated with the queue. Voting details are reported to the monitors to help assure that inefficiencies and irregularities in voting can be found and addressed.

### BRIEF DESCRIPTION OF THE DRAWINGS

FIG. 1 illustrates a typical environment of users, computers, printers, and messaging fabric in which embodiments can be implemented

FIG. 2 illustrates a typical workflow by which a person creates a document and then causes it to be printed to yield a publication.

FIG. 3 illustrates an example of a queue in accordance with features of the embodiments.

FIG. 4 illustrates a subscriber list in accordance with features of the embodiments.

FIG. 5 illustrates a high level flow chart of operations of logical operational steps that can be implemented in accordance with another feature of the embodiments.

FIG. 6 illustrates a high level flow chart of operations of logical operational steps that can be implemented in accordance with another feature of the embodiments.

FIG. 7 illustrates a high level flow chart of operations of logical operational steps that can be implemented in accordance with another feature of the embodiments.

FIG. 8 illustrates a high level flow chart of operations of logical operational steps that can be implemented in accordance with another feature of the embodiments.

FIG. 9 illustrates a queue rating list in accordance with another feature of the embodiments.

FIG. 10 illustrates a high level flow chart of operations of logical operational steps that can be implemented in accordance with another feature of the embodiments.

FIG. 11 illustrates a high level flow chart of operations of logical operational steps that can be implemented in accordance with another feature of the embodiments.

FIG. 12 illustrates a high level flow chart of operations of logical operational steps that can be implemented in accordance with another feature of the embodiments.

FIG. 13 illustrates a high level flow chart of operations of logical operational steps that can be implemented in accordance with another feature of the embodiments.

FIG. 14 illustrates a high level flow chart of operations of logical operational steps that can be implemented in accordance with another feature of the embodiments.

FIG. 15 illustrates a high level flow chart of operations of logical operational steps that can be implemented in accordance with another feature of the embodiments.

FIG. 16 illustrates a high level flow chart of operations of logical operational steps that can be implemented in accordance with another feature of the embodiments.

FIG. 17 illustrates a high level flow chart of operations of logical operational steps that can be implemented in accordance with another feature of the embodiments.

FIG. 18 illustrates a voter list that can be associated with a queue in accordance with another feature of the embodiments.

FIG. 19 illustrates a high level flow chart of operations of logical operational steps that can be implemented in accordance with another feature of the embodiments.

FIG. 20 illustrates a high level flow chart of operations of logical operational steps that can be implemented in accordance with another feature of the embodiments.

FIG. 21 illustrates a high level flow chart of operations of logical operational steps that can be implemented in accordance with another feature of the embodiments.

FIG. 22 illustrates a monitor list that can be associated with a queue in accordance with another feature of the embodiments.

FIG. 23 illustrates a high level flow chart of operations of logical operational steps that can be implemented in accordance with another feature of the embodiments.

### DETAILED DESCRIPTION

The particular values and configurations discussed in these non-limiting examples can be varied and are cited merely to illustrate embodiments that are not intended to limit the scope of the embodiments.

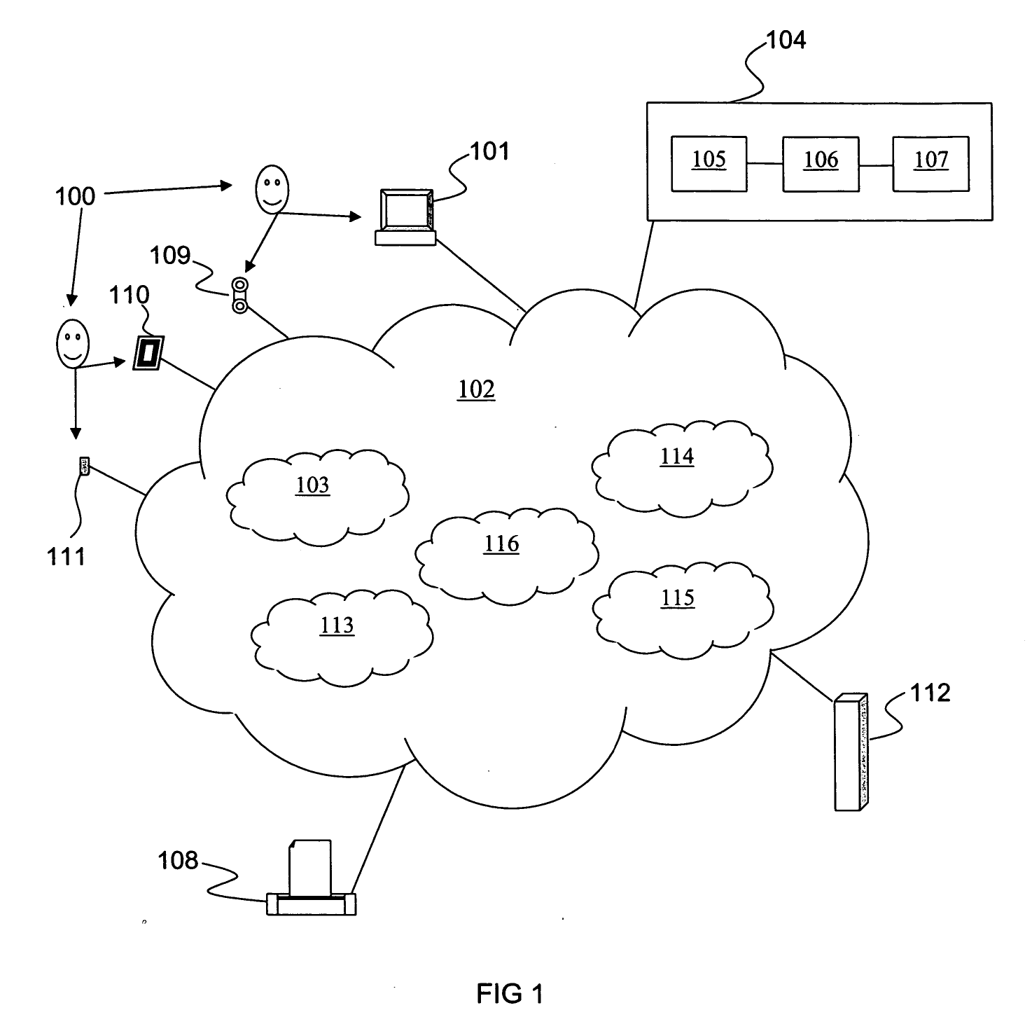

FIG. 1 shows a typical environment of users, computers, printers, and messaging fabric. A user 100 can use a computer 101 to create documents, create queues, create print jobs, communicate via the messaging fabric 102, and submit print jobs to a printer. The messaging fabric 102 includes the different ways that people and computers can communicate, such as the internet 103, cell phone network 113, paging networks 115, telephone networks 114, and instant messaging networks 116. A large commercial printer 104 containing elements such as a digital front end (DFE) 105, prepress 106, and offset press 107 also communicates via the messaging fabric 102. A smaller printer 108 also communicates via the messaging fabric. Other users also communicate via the messaging fabric 102. One user 100 communicates via a cell phone 109. Another user 100 communicates via a pager 110. A third user 100 communicates via an instant messaging device 111, such as a blackberry. An LDAP server 112 also communicates via the messaging fabric 102. LDAP, which stands for Lightweight Directory Access Protocol, is a standardized means for accessing an electronic directory. An electronic directory, like any other directory, is used to discover the means by which someone or something may be communicated with. Using an example based on FIG. 1, suppose the cell phone user wanted to communicate with the pager user but did not know how. The cell phone user could send a request to the LDAP server. The LDAP server would return the pager number. The cell phone user could then send a page or the cell phone itself could send a page without further human input.

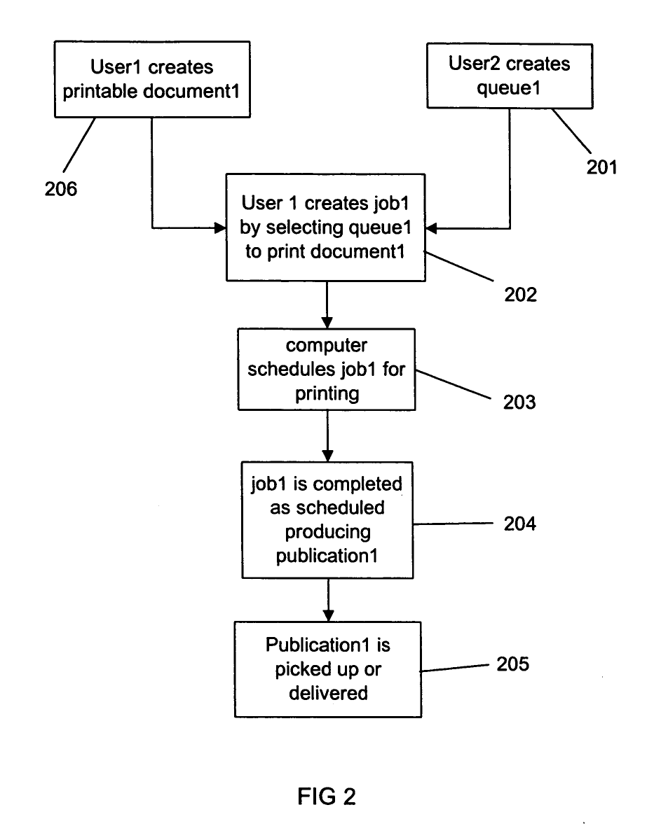

FIG. 2 shows a typical workflow by which a person creates a document and then causes it to be printed to yield a publication. Before anything can be printed, a user must create a document 206. As mentioned earlier, the term document is used here to refer to the design of a publication. Typically, the design of a publication is an electronic file created with a desktop publishing system. Another requirement for printing is that there is at least one queue for the user to use. A user can also create a queue 201. The user who creates the queue can be the same user who creates the document or can be a different one. Next, a user creates a print job 202 by selecting a document and selecting a queue to print it. The user who creates the print job can be different from those who create the document or queue. The print job is then submitted to a computer that schedules the print job for completion 203. The print job is performed as scheduled 204 to yield a publication. Finally, the publication can be picked up by the requesting user or distributed in some other manner 205. FIG. 2 shows an ideal work flow. The problems the present embodiments address occur when the queue is changed. The number of ways queue changes and the associated problems that can occur are large. However, methods to avoid those problems can be employed.

Note that features of the embodiments can be implemented in the context of modules. In the computer programming arts, a module can be typically implemented as a collection of routines and data structures that performs particular tasks or implements a particular abstract data type. Modules are generally composed of two parts. First, a software module may list the constants, data types, variables, routines and the like that can be accessed by other modules or routines. Second, a software module can be configured as an implementation, which can be private (i.e. accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implanted through signal bearing media, including transmission media and recordable media. Certain structures can be implemented as modules in accordance with embodiments and alternative embodiments of the present embodiments. Those structures include, but are not limited to, queues 300, subscriber lists 400, queue rating lists 900, voter lists 1800, and monitor lists 2200.

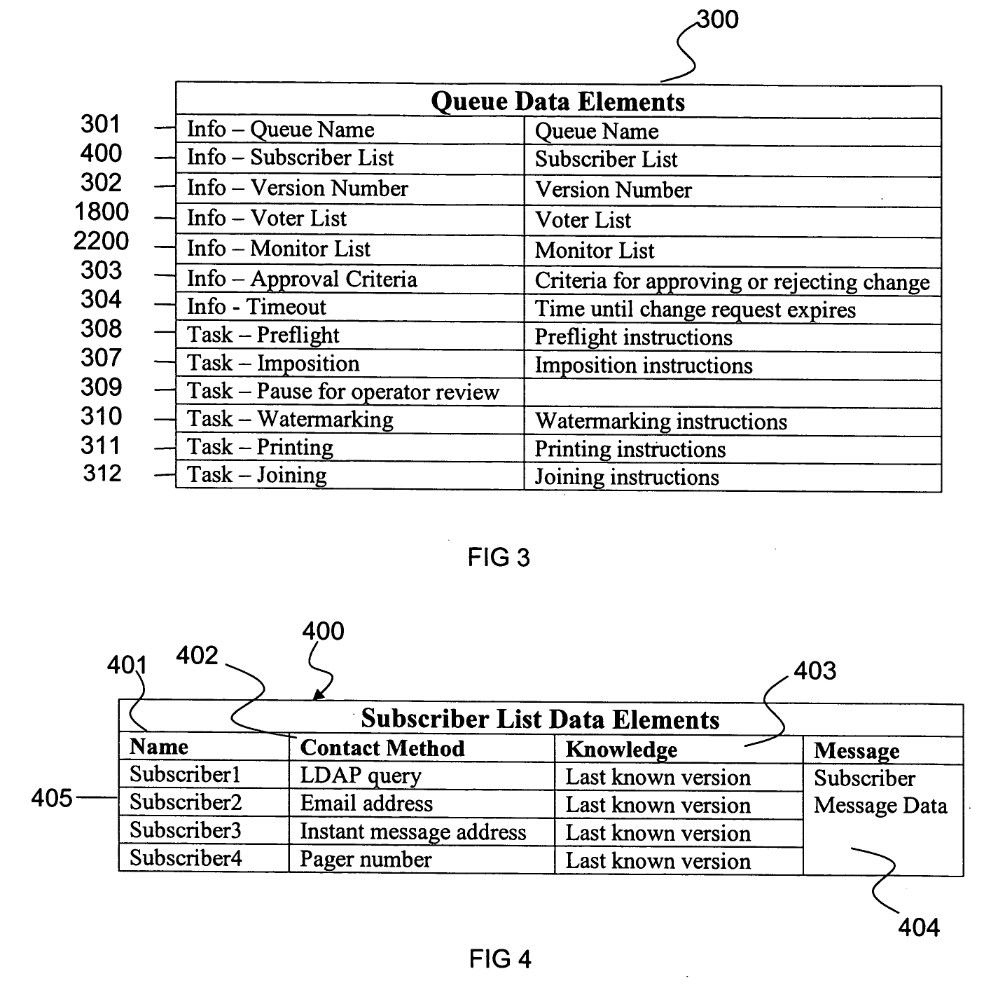

An example of a queue is shown in FIG. 3. A queue 300 is a data collection including helpful information and task details specifying how a print job is to be completed. The queue shown has some elements marked as info, they relate to information. The queue also contains elements marked as tasks, they relate to specific tasks that must be performed to transform a document into a publication. The elements marked as tasks are present in prior art queues. The elements marked as info are used in conjunction with different features of the present embodiments. Furthermore, the queue of FIG. 3 is not intended to show everything that must be in a queue, but it does include elements necessary to enable the various features of the present embodiments. A queue must have a name 301. The name is required so that the queue may be referred to. People specify queues. As such, the queue name must be readable by a person. Furthermore, if two queues have the same name, then people are likely to confuse them. One aspect is that every queue has a unique name in order to avoid confusion. Another aspect is that queue names need not be unique, but that there is some other way to tell them apart. The queue contains a subscriber list 400, which will be discussed in detail later.

A queue can contain a version number 302. Version numbers are used to track changes to the queue. Typically, a queue is created with the version number set to 1. The version number is then incremented every time the queue is changed. A queue can contain a voter list 1800. Voter lists will be discussed in detail later. A queue can contain approval criteria 303. Approval criteria will be discussed in detail later. A queue can contain a timeout 304. The timeout will be discussed in detail later. A queue can contain an imposition task 307.

Imposition is the manner in which a document is printed on sheets of paper. An example is printing the pages such that they may be stapled together and folded to form a pamphlet. A queue can contain a preflight task 308. Preflight is an operation by which the job is checked by the computer to be sure there are no obvious errors. A queue can contain a pause for approval task 309 so that a person can also check the print job for errors. A queue can contain a watermarking task 310. A watermark is a faint pattern on a page. Watermarking is the process of placing watermarks. A queue can contain a printing task 311. Printing is the act of placing text and images onto a printable substrate such as paper. A queue can contain a joining task 312. Joining is the process of combining sheets to form a publication. Examples are stapling a pamphlet or binding a book.

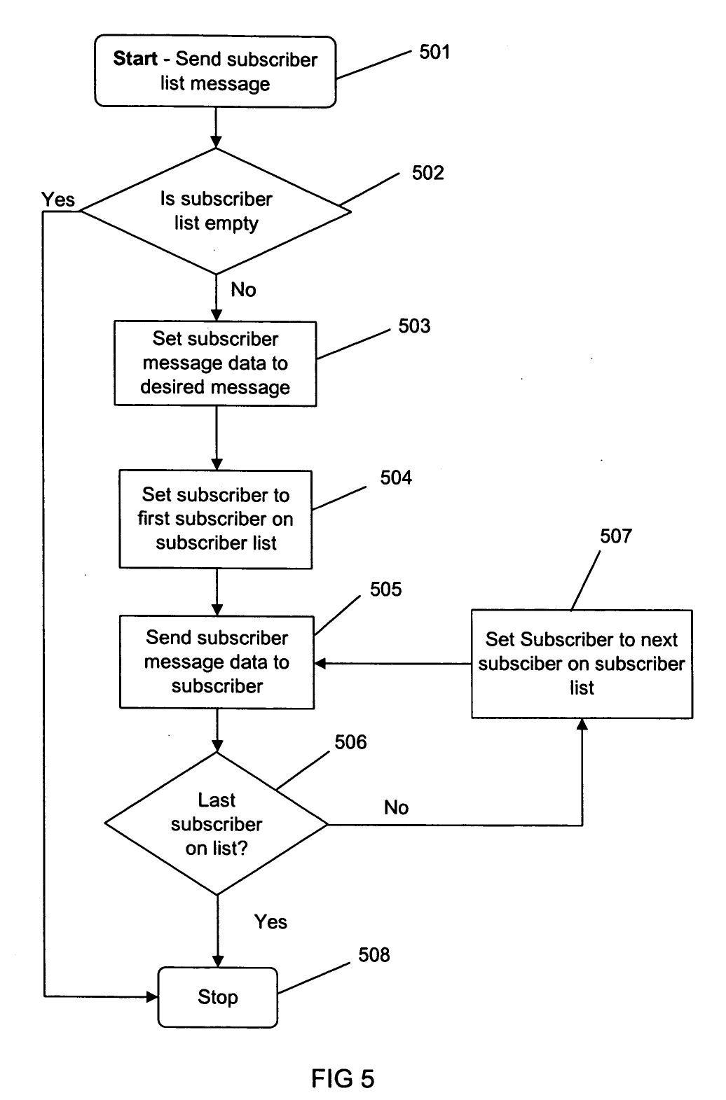

FIG. 4 shows a subscriber list 400. A subscriber is a person who is interested in a queue. Someone with a pending print job that uses a queue is interested and should be a subscriber. Someone who is expected to use the queue in the future, such as a past user, can be a subscriber. People who are involved in the creation and oversight of the queue can be subscribers. The people who have some interest in a queue and could be a subscriber is boundless and is, in reality, set by the policies of whoever or whatever actually controls the resources in keeping queues and operating printing equipment. In the embodiments discussed herein, the subscriber list 400 contains subscribers 401, a way to contact each subscriber 402, each subscriber's knowledge with respect to a queue 403, and some message data 404. For example, Subscriber2 405 is to be contacted via email. Some aspects of the present embodiments require that the subscriber's knowledge of the queue be tracked. The reason is that it can be necessary to determine if the subscriber already knows about the current version of the queue or which version the subscriber actually knows about. Finally, the message data 404 is used to store a message that must be sent to the entire subscriber list. Some aspects of the present embodiments do not require every element of the subscriber list shown in FIG. 4. The present embodiments require every queue 300 to have a subscriber list 400.

FIG. 5 shows a process for sending a message to all the subscribers on a subscriber list 400. First, the task must be started 501. If the subscriber list is empty 502, then stop 508 trying to send the message. Next, set the subscriber message data 404 to whatever message is to be sent 503. Next, get the information for the first subscriber on the subscriber list 504. Send the message to the subscriber by using the subscriber's contact method 505. If all the subscribers have been sent the message 506, then stop 508. Otherwise, get the information for the next subscriber on the list 507 and go back to step 505.

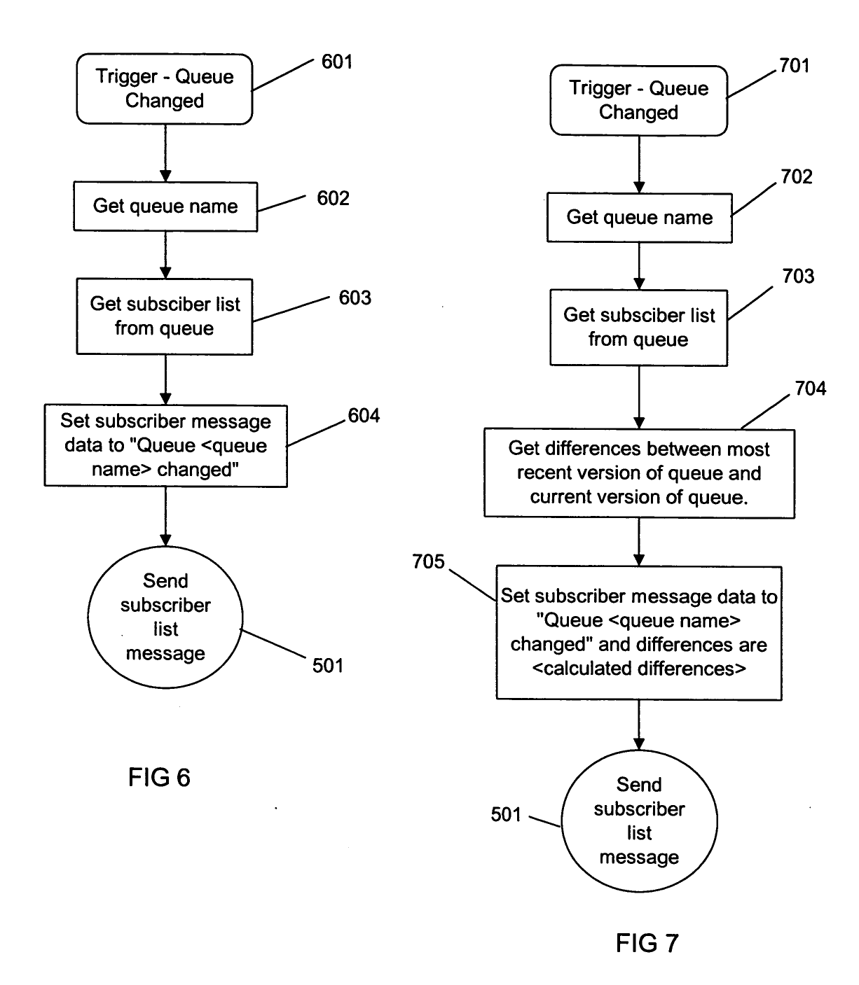

In accordance with a feature of the present embodiments, changing a queue results in triggering the process shown in FIG. 6. After the process is triggered 601, the queue name 301 is read from the queue 602. Next, the subscriber list 400 is also obtained from the queue 603. The subscriber message data 404 is then set to indicate that the queue has changed 604. Finally, the message is sent via the send message process 501.

In accordance with another feature of the present embodiments, changing a queue results in triggering the process of FIG. 7. After the process is triggered 701, the queue name 301 is read from the queue 702. Next, the subscriber list 400 is obtained from the queue 703. Next, the difference between the current version of the queue and the previous version is calculated 704 as described below. The reason is that instead of telling the subscriber that the queue changed, this feature tells the subscriber specifically what changed. Next, the subscriber message data 404 is set to indicate that the queue has changed and what the changes are 705. Finally, the message is sent via the send message process 501.

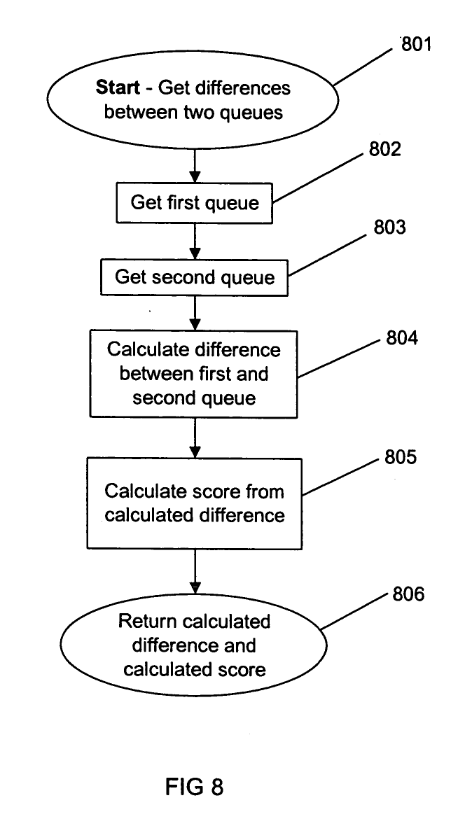

FIG. 8 shows a process of calculating differences between queues and calculating a score based on the changes. After the process is started 801, the first queue is obtained 802 and then the second queue is obtained 803. Next the differences between the queues are calculated 804. The present embodiments do not specify how differences are calculated, but makes note that algorithms for calculating the differences between files, computer programs, and text strings already exist. Any existing algorithm or a purpose built algorithm can be used. For the feature discussed here, a context difference based on Larry Wall's open source diff program is sufficient. Using the calculated difference, a calculated score can be found 805. For the feature discussed here, the calculated score can be the number of text characters in the context difference between the two queues. There are many ways to calculate the difference and the score. However, for purposes of this feature of the present embodiments, all those methods are equivalent. Finally, the calculated difference and the calculated score are returned 806.

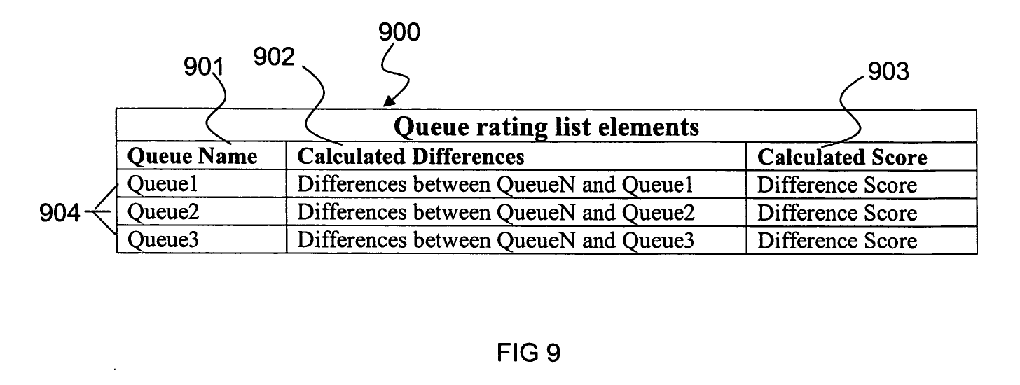

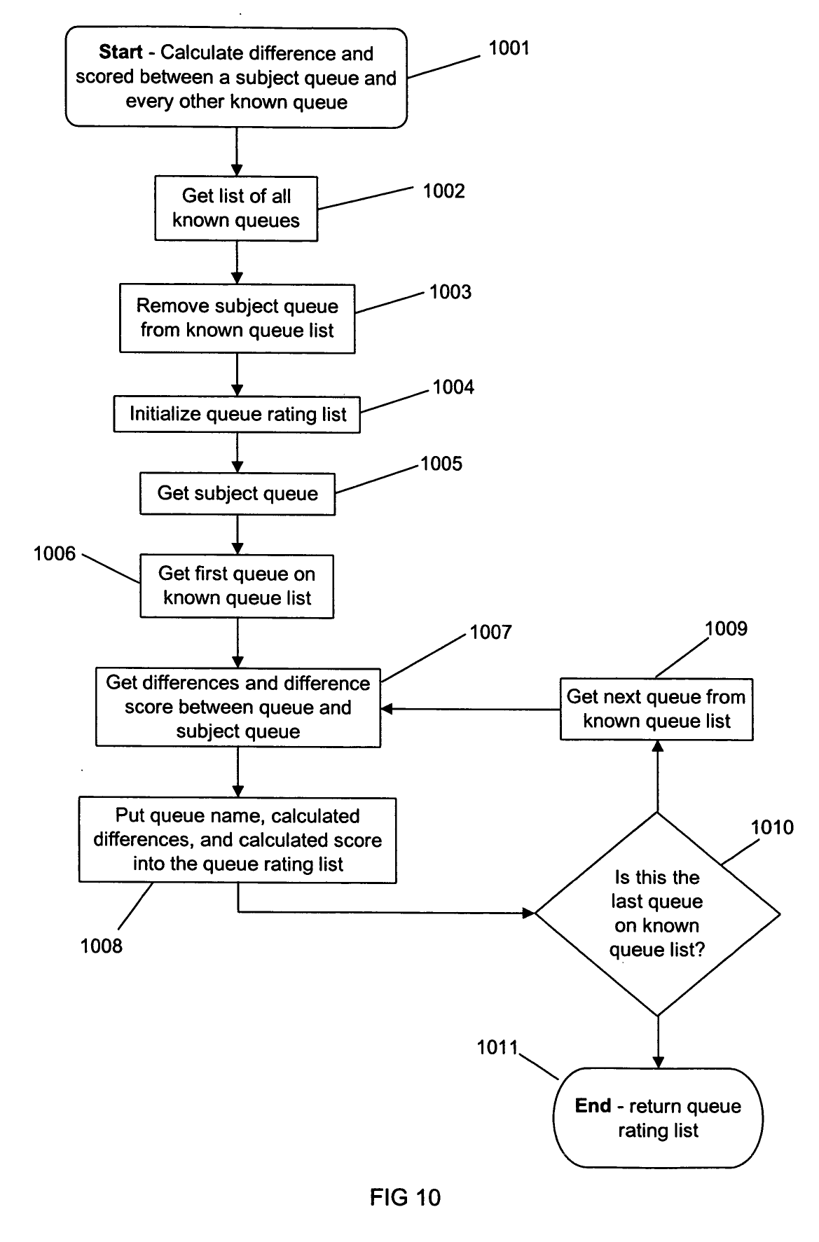

Certain features of the present embodiments require knowledge of the calculated difference and calculated score between a subject queue and every other known queue. FIG. 10 shows a process for making the required calculations and placing them into a queue rating list as shown in FIG. 9.

A queue rating list 900 is used to store information about the calculated difference 902 and calculated score 903 between a subject queue and a set of other queues 901. A process such as that shown in FIG. 8 performs the calculations. Here, the queue rating list is presented as a table with one row for every queue 904 that is compared to the subject queue. The functionality of the queue rating list 900 may be implemented in many different ways. However, for purposes of this feature of the present embodiments, all those ways are equivalent.

FIG. 10 shows a process for obtaining a queue rating list that contains all the calculated differences and calculated scores between a subject queue and every other known queue. First, the process is started 1001. Next a list of all known queues is obtained 1002. To get a publication, a user needs to specify a document and a queue. The user can have many queues to choose from. A known queue is any queue that a user could choose. Next the subject queue is removed from the list of known queues 1003. The reason is there is no difference between the subject queue and itself. Next, a queue rating list is initialized 1004. Initialization means preparing the list to accept new data. Two of the many ways to initialize the queue rating list is to create a new one or to empty an existing one. Next, the subject queue is obtained 1005 and the first queue on the known queue list is obtained 1006. Next, a process such as that in FIG. 8 is used to obtain the calculated difference and calculated score between the two queues 1007 and the results are put into the queue rating list 1008. If this is the last queue on the known queue list 1010, then return the queue rating list 1011. Otherwise, get the next queue 1009 and go back to step 1007.

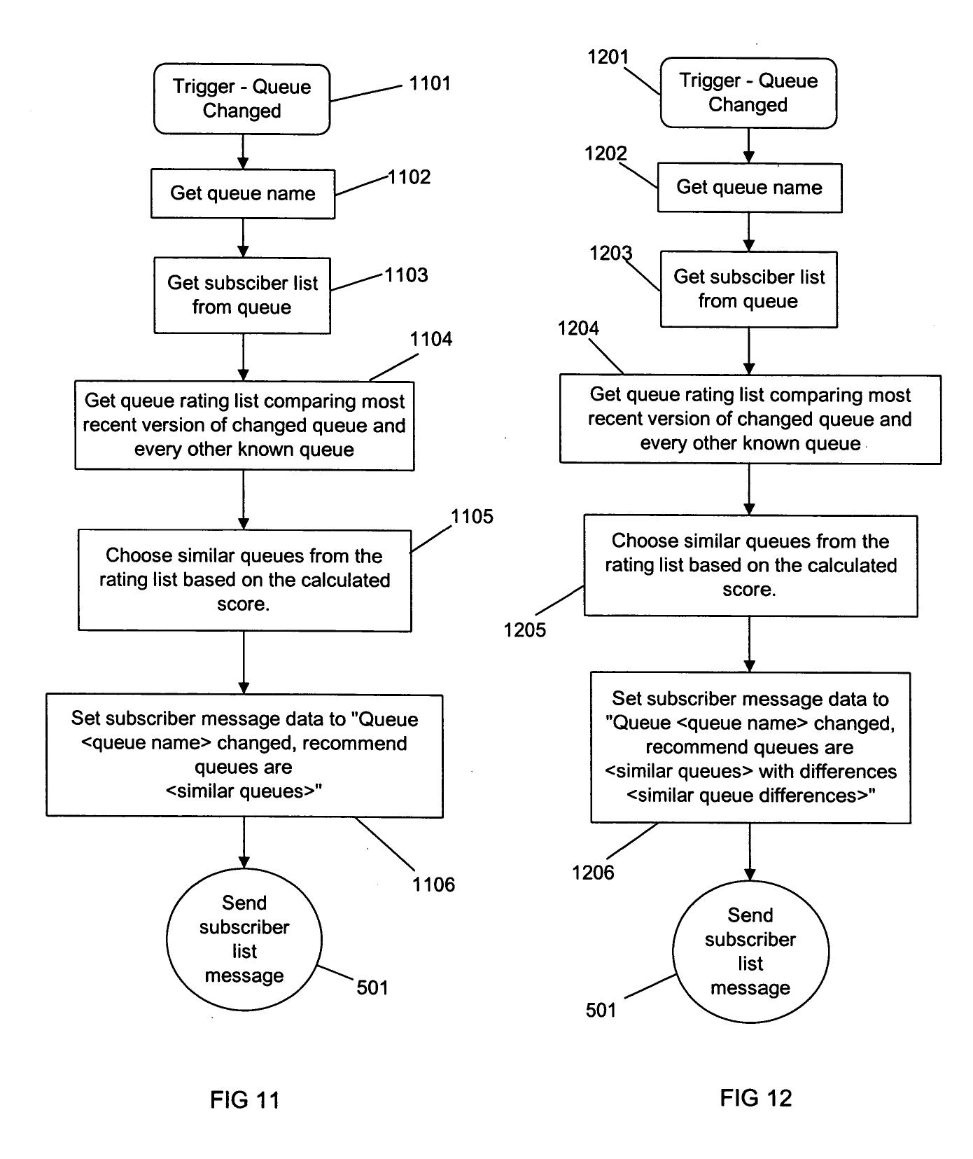

In accordance with another feature of the present embodiments, changing a queue results in triggering the process of FIG. 11. The purpose of this feature is to recommend other queues that the subscribers could use instead of the queue that has been changed. After the process is triggered 1101, the queue name 301 is read from the queue 1102. Next, the subscriber list 400 is also obtained from the queue 1103. Next a queue rating list is obtained comparing the most recent version of the changed queue and every other known queue 1104 via a process such as that in FIG. 10. The most recent version of the changed queue is the version before the changes took place and also the version that the subscribers are most familiar with. Next, queues that are similar to the most recent version of the changed queue are chosen from the queue rating list 1105 based on the calculated score. The chosen queues are the ones that the subscribers might find preferable to the queue that has been changed. A message is then assembled to inform the subscribers what queue has changed and what other queues they may now find preferable 1106. Finally, the message is sent via the send message process 501.

In accordance with another feature of the present embodiments, changing a queue results in triggering the process of FIG. 12. The process of FIG. 11 alerted subscribers to the changed queue and made recommendations but did not tell them what was different between the most recent version of the changed queue and the recommended queues. The process of FIG. 12 does tell the subscribers what those differences are. The difference between the process of FIG. 11 and that of FIG. 12 is seen in process blocks 1106 and 1206 where the subscriber message is assembled. In process block 1206, the message is assembled to include the calculated differences.

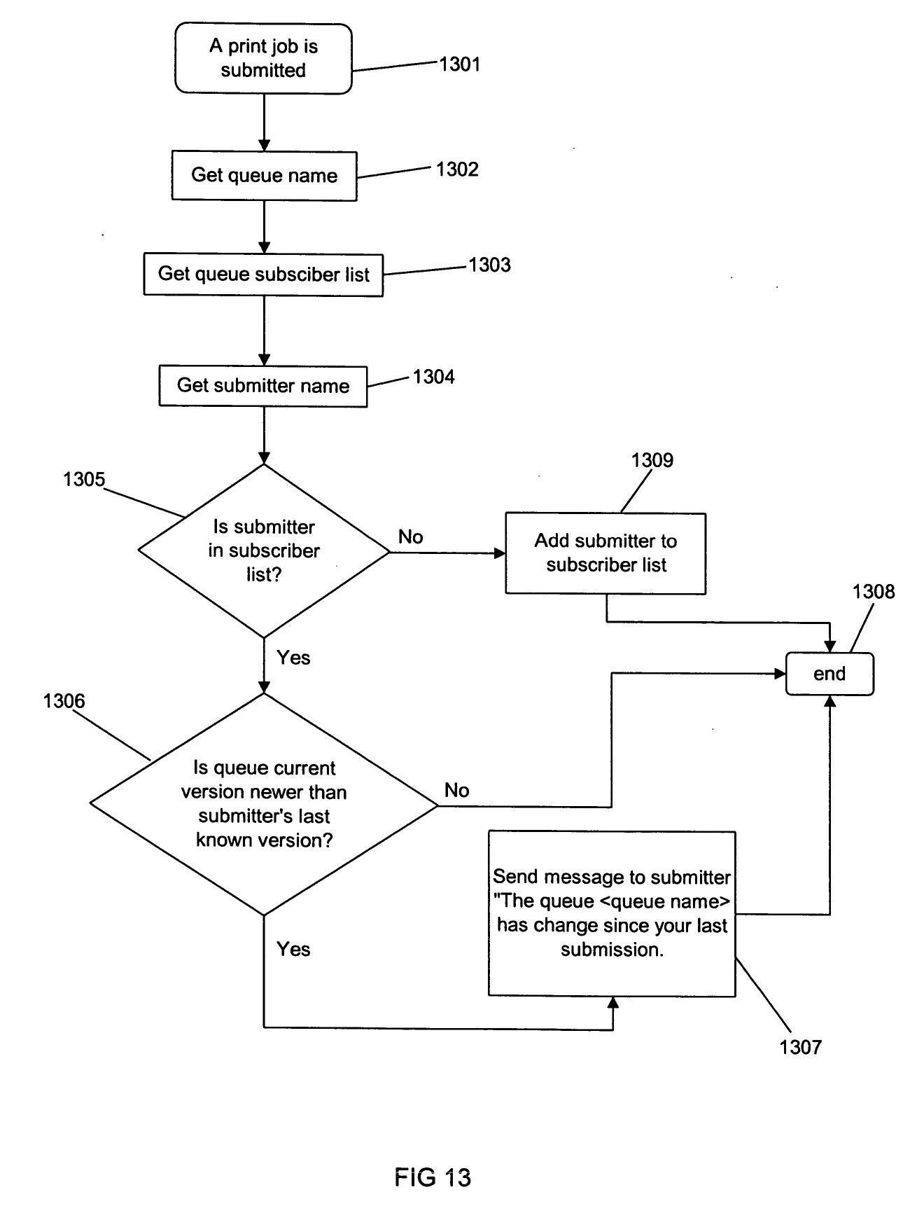

In accordance with another feature of the present embodiments, a subscriber is not told that a queue has changed until that subscriber submits a print job using the changed queue. The process of FIG. 13 is triggered when a user submits a print job 1301. First, the queue name 1302, queue subscriber list 1303, and submitter name 1304 are obtained. If the submitter is not on the subscriber list 1305, then the submitter, who doesn't know about any previous queue version, is added to the subscriber list 1309 and the process ends 1308. If the submitter is on the subscriber list 1305, then the submitter's knowledge of the queue is compared to the current queue. The comparison is performed using version numbers 1306. The queue has a version number. The last time the subscriber used the queue, the queue had a version number and that version number is the subscriber's current knowledge. If the subscriber's current knowledge does not match the queue's current version number 1306, then the submitter is alerted that the queue has changed 1307 and then the process ends 1308

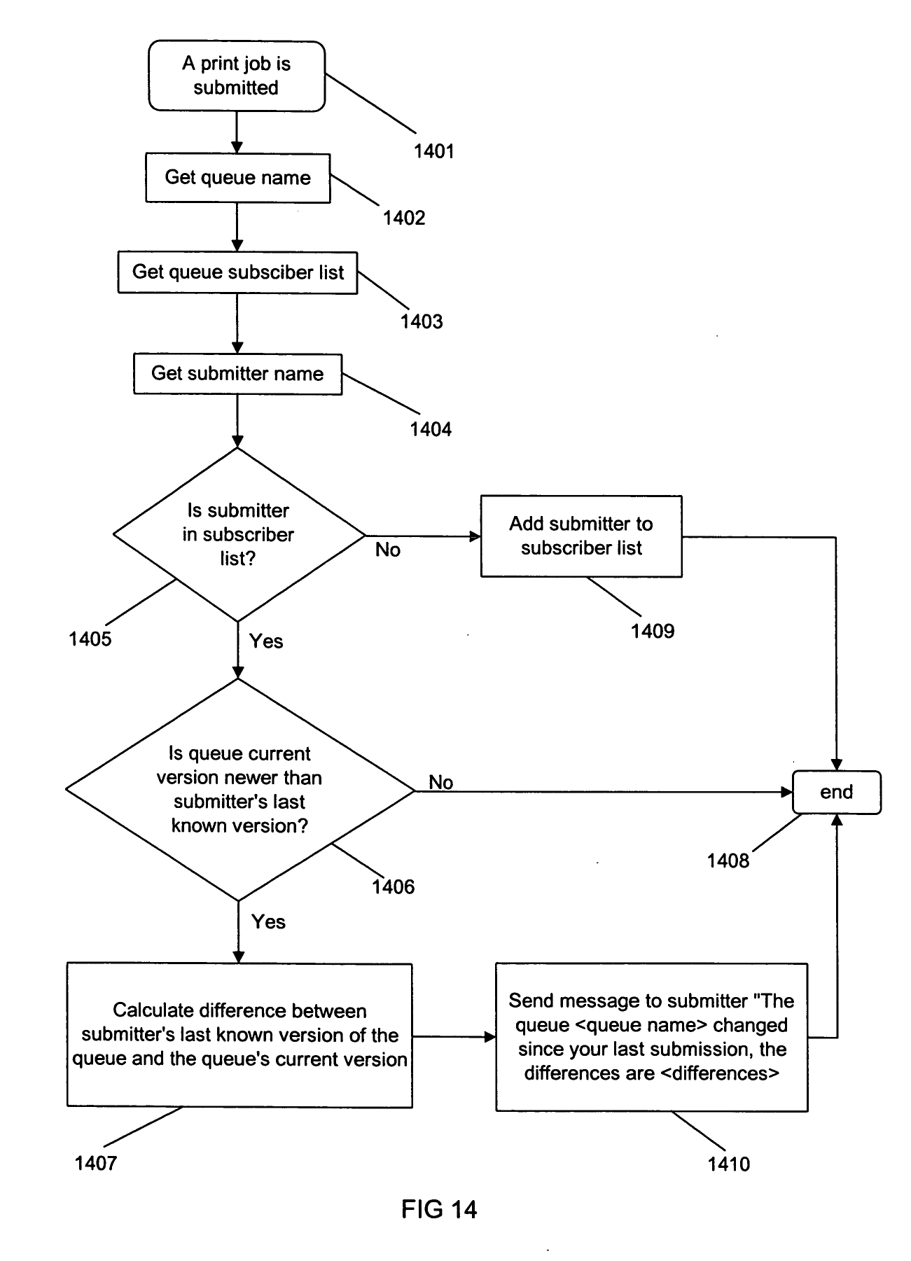

In accordance with another feature of the present embodiments, a subscriber is not told that a queue has changed until that subscriber submits a print job using the changed queue. Upon submitting a print job using the changed queue, the subscriber is told that the queue changed and what the changes are. The process of FIG. 14 shows this aspect of the present embodiments, which differs from the process of FIG. 13 at process block 1307. In the process of FIG. 14, if the subscriber's current knowledge does not match the queue's current version number 1406, then the difference between the subscribers last known version of the queue and the current version are calculated 1407. Then the subscriber is alerted that the queue has changed and what the changes are 1410. Finally, the process ends 1408.

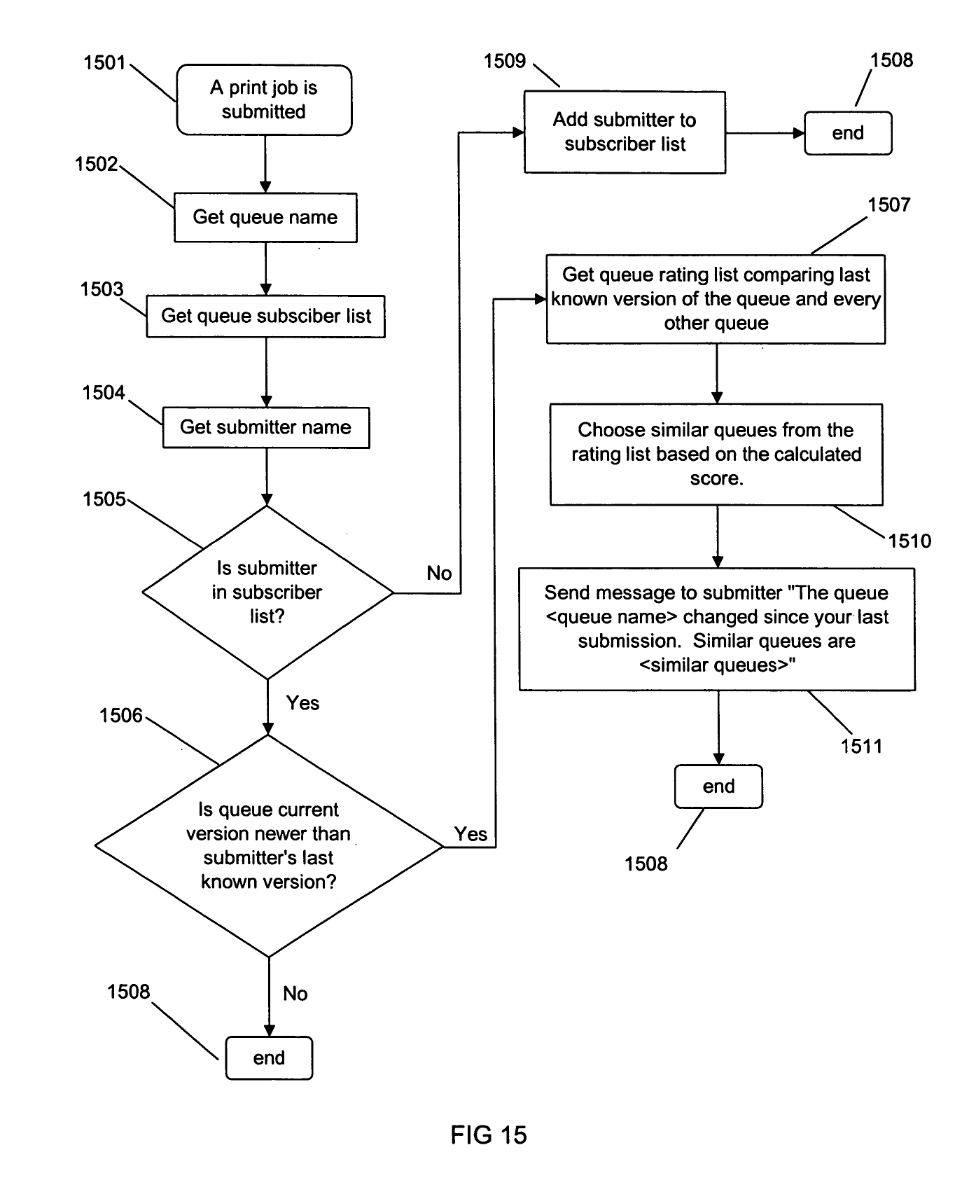

In accordance with another feature of the present embodiments, a subscriber is not told that a queue has changed until that subscriber submits a print job using the changed queue. Upon submitting a print job using the changed queue, the subscriber is told that the queue changed and alternative queues are recommended. The process of FIG. 15 shows this aspect of the present embodiments, which differs from the process of FIG. 13 at process block 1307. In the process of FIG. 15, if the subscriber's current knowledge does not match the queue's current version number 1506, then a queue rating list comparing the version the subscriber knows about and all known queues is generated 1507. A group of similar queues that may meet the subscriber's needs is then picked from the queue rating list based on the calculated scores 1510. Next, a message is sent alerting the submitter that the queue changed and recommending the similar queues 1511. Finally, the process ends 1508.

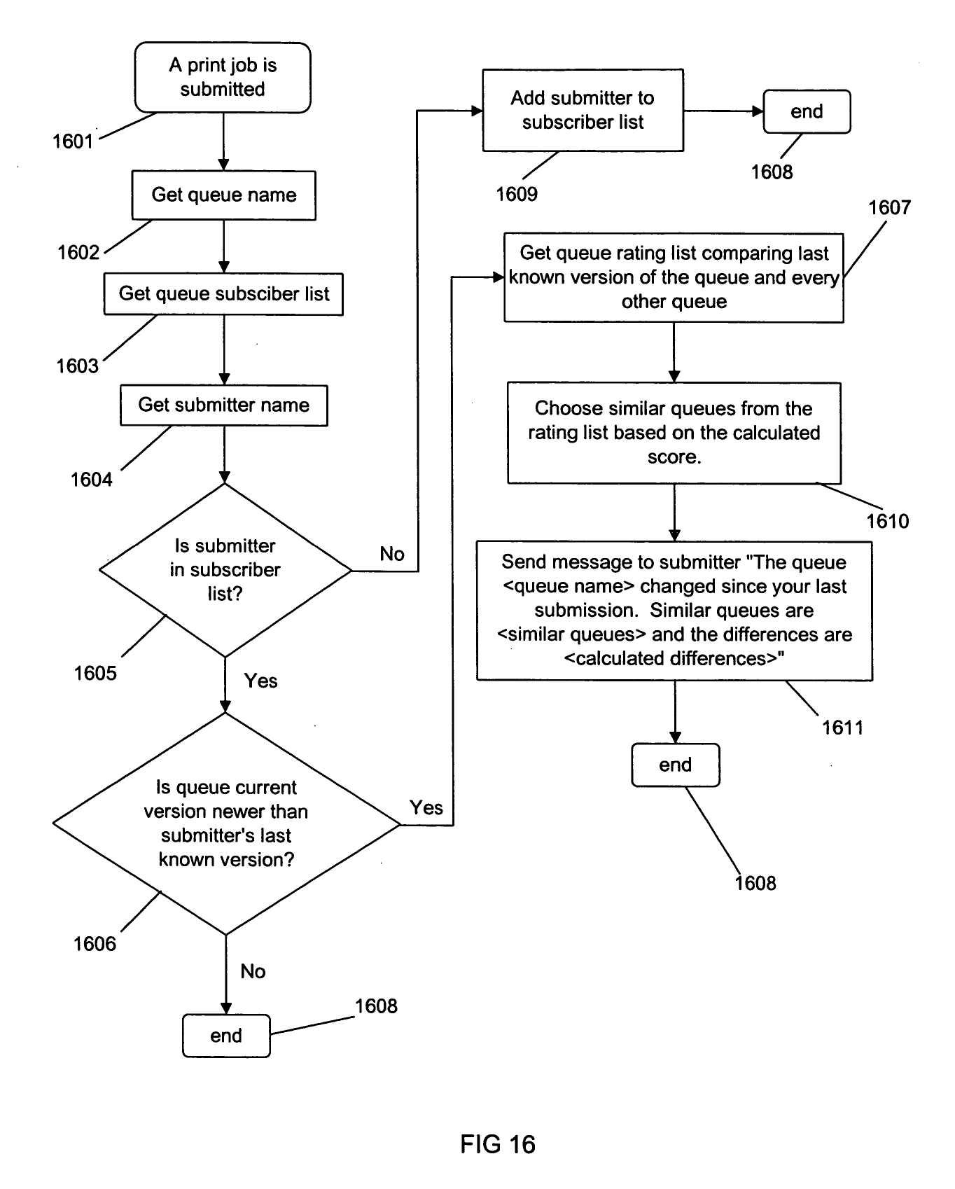

In accordance with another feature of the present embodiments, a subscriber is not told that a queue has changed until that subscriber submits a print job using the changed queue. Upon submitting a print job using the changed queue, the subscriber is told that the queue changed, alternative queues are recommended, and what the differences are between the recommended queues and the queue the subscriber expected to use. The process of FIG. 16 shows this aspect of the present embodiments, which differs from the process of FIG. 15 at process block 1511. In the process of FIG. 16, the calculated differences between the recommended queues and the version of the changed queue the subscriber knows about are included in the alert 1611.

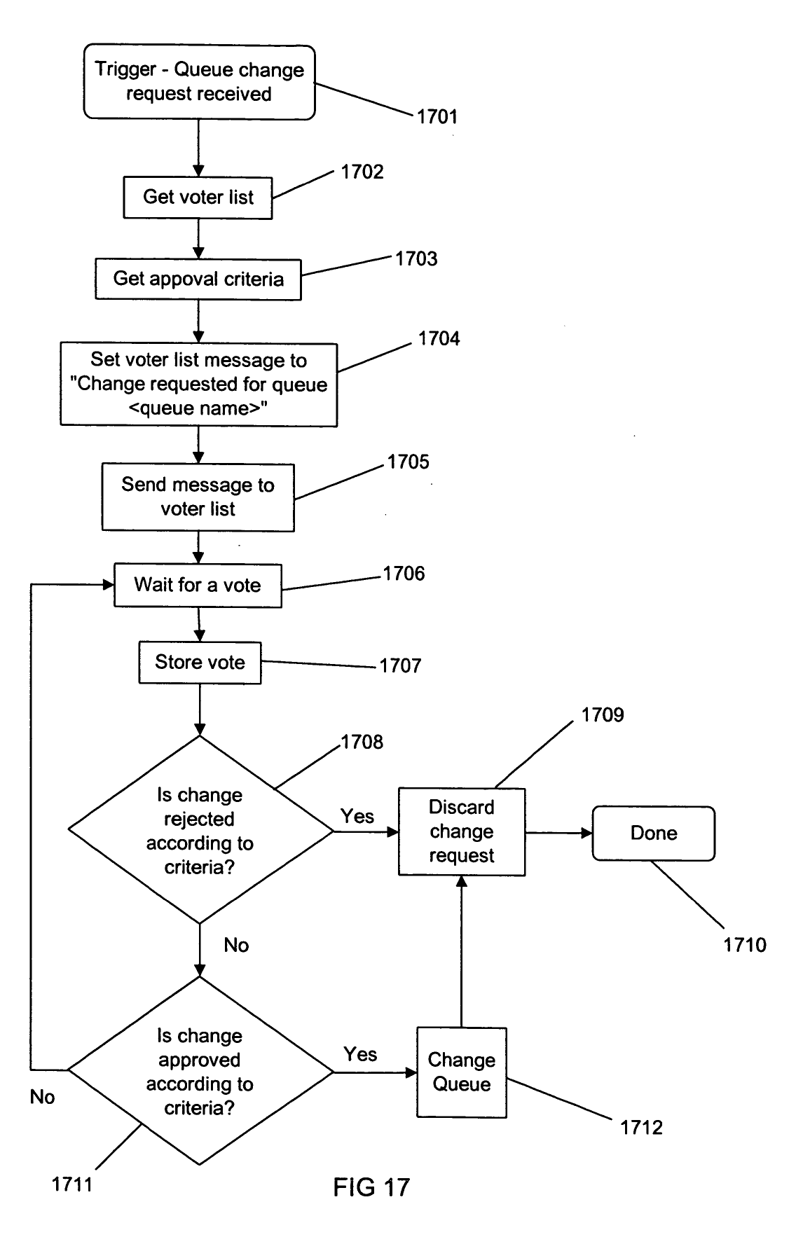

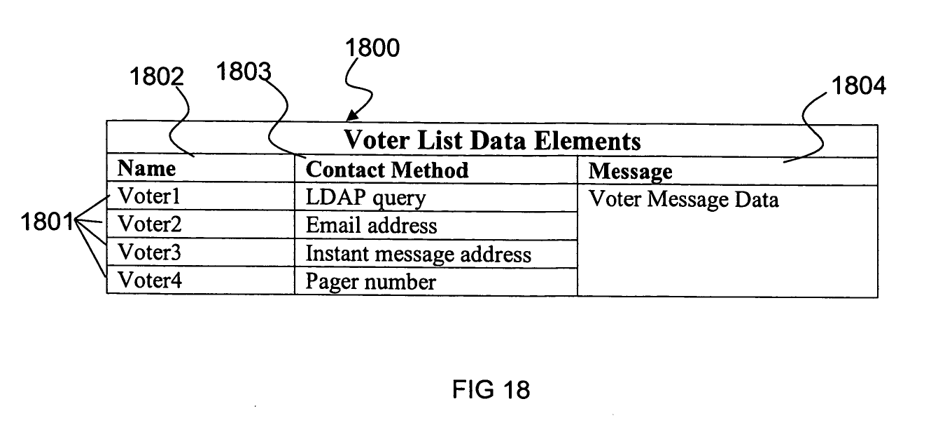

In accordance with another feature of the present embodiments, a queue cannot be changed unless the change is first approved via a voting mechanism such as that shown in FIG. 17. For voting to occur, there must be a voter list 1800 and approval criteria 303. In the preferred embodiment of the present embodiments, they are stored as queue info elements. An example of a voter list is shown in FIG. 18. The voter list is similar to the subscriber list 400 of FIG. 4. The voter list 1800 is presented here as a table with one table row per voter 1801. Each voter has a name 1802 and a contact method 1803. All the voters share the voter message data element 1804 that is used similarly to the subscriber message data 404. A process similar to that in FIG. 5 is used to send the voter message data to all the voters. Approval criteria 303 are used to determine when voting has resulted in a decision. For example, the approval criteria could be that a majority of voters must approve a change. If there are 5 voters, then 3 yes votes approve the change and 3 no votes reject it.

In accordance with another feature of the present embodiments, a queue change approval process based on voting is shown in FIG. 17. The process is triggered 1701 when a change request for a queue is received. Next, the voter list is obtained 1702 and then the approval criteria are obtained 1703. Next, a change request alert is composed 1704 and sent to all voters 1705. The process then waits for the votes to arrive 1706. When a vote arrives, it is stored 1707. Then the approval criteria is checked against the votes that have arrived so far to see if the change is rejected 1708. If the change is rejected, then the change request is discarded 1709 and the process ends 1710. Otherwise, the approval criteria are checked against the votes that have arrived so far to see if the change is accepted. If the change is accepted, then the change is made 1712, the change request is discarded 1709, and the process ends 1710. Otherwise, the process goes back to waiting for votes to arrive 1706.

In accordance with one aspect only votes for approval are accepted with disapproval being indicated by abstention. A different aspect is that only votes for against approval are accepted with approval being indicated by abstention. Another different aspect is that votes for approval and disapproval are accepted wherein abstentions are interpreted as per the voting criteria. Another different aspect is that votes for approval, disapproval, and don't care are accepted wherein abstentions are interpreted as per the voting criteria. Abstention can be treated as an approval, disapproval, don't care, or unknown. A don't care vote is different from an abstention in that the voter did respond. It can have a different effect for some voting criteria. For example, a voting criteria requiring a majority for approval could treat don't care votes as a reduction in the number of voters. In this example, 2 approvals, 1 disapproval, and 2 don't cares would result in approving a change request. However, 2 approvals, 1 disapproval, and 2 abstentions would result in disapproving a change request

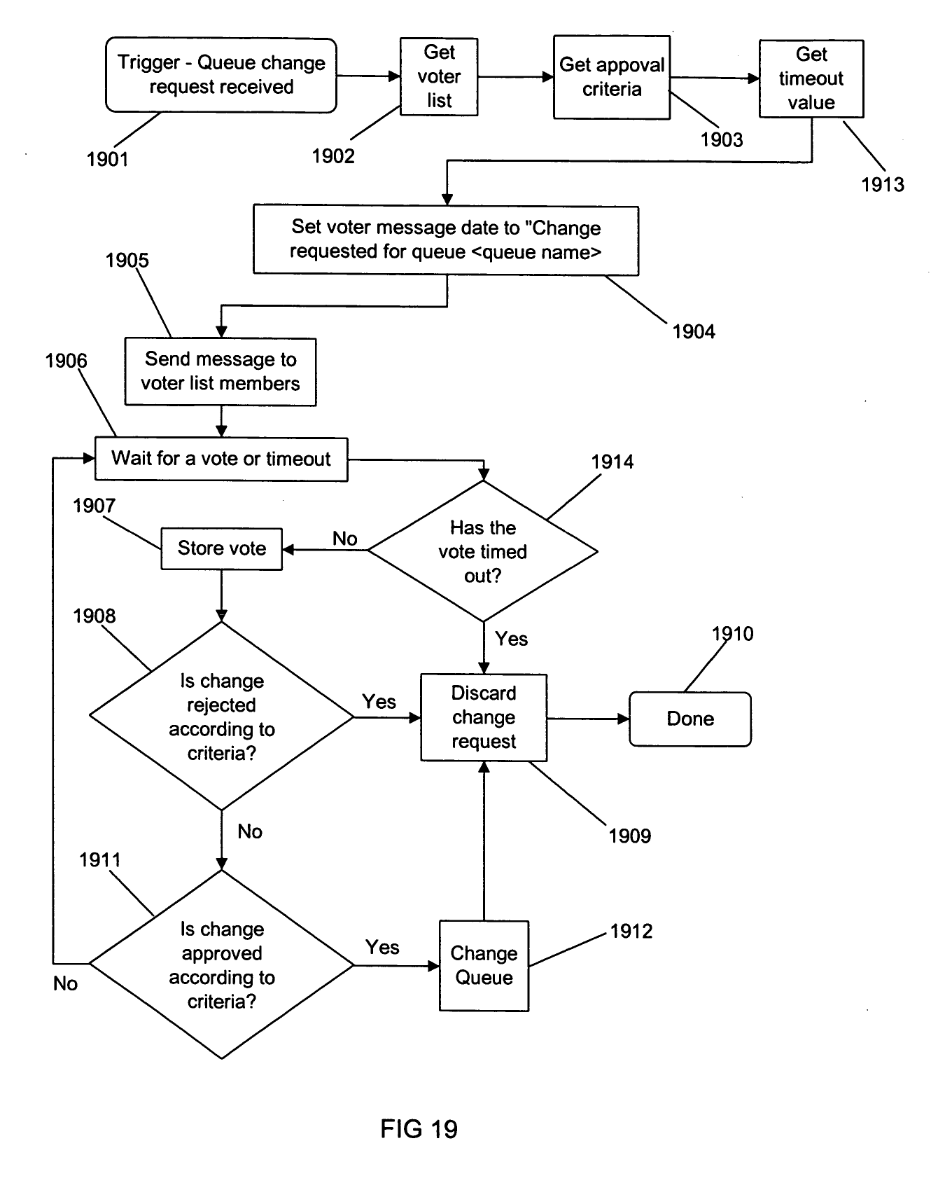

In accordance with another feature of the present embodiments, a queue change approval process based on voting with a timeout is shown in FIG. 19. The timeout is a limit on the amount of time allowed for voting. For example, a 1 day timeout means that if the change is not either accepted or rejected in 1 day, then the change is automatically rejected. The process of FIG. 19 is similar to the process of FIG. 17. One difference is that a timeout value is obtained 1913. Another difference is that process block 1706 is modified to include waiting for a timeout event in process block 1906. When a vote or timeout is received, the process immediately checks for a timeout 1914. If there was a timeout, then the change request is discarded 1909 and the process ends 1910.

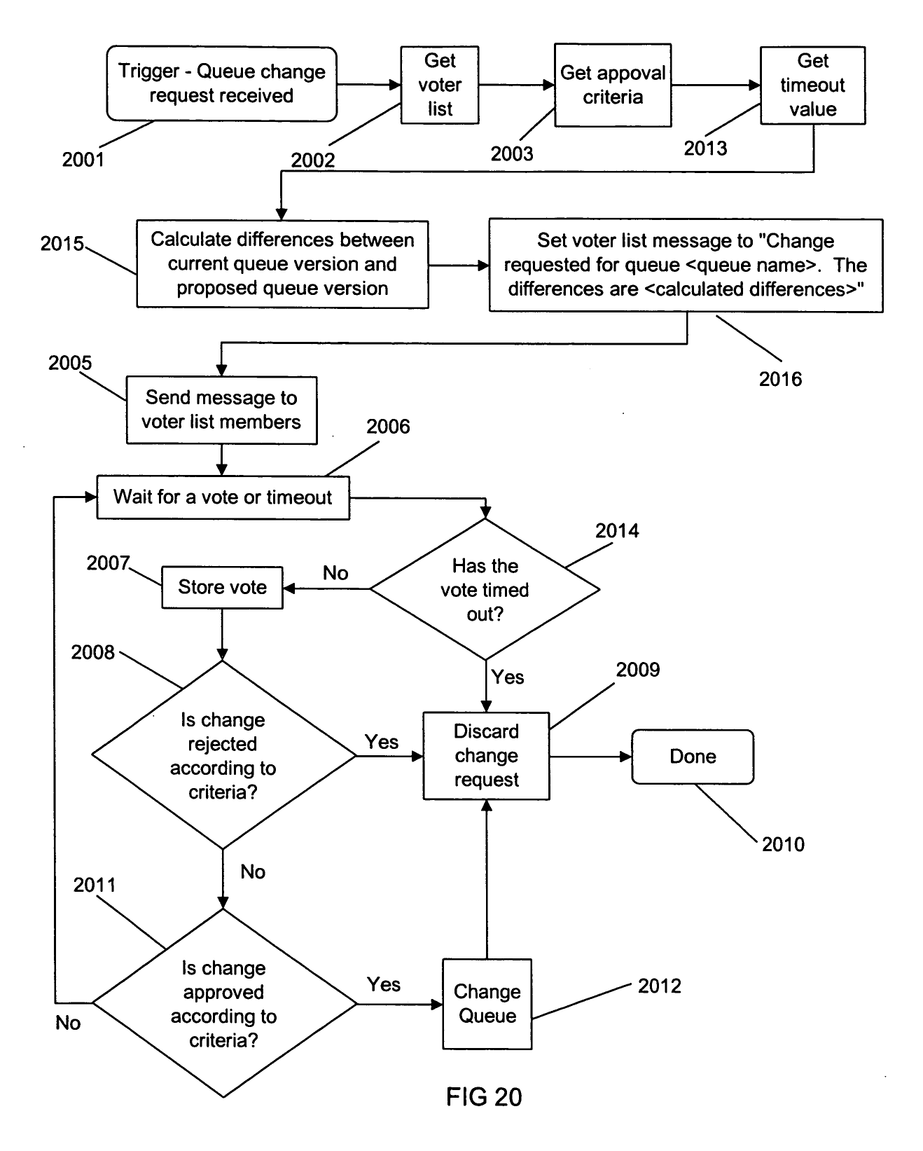

In accordance with another feature of the present embodiments, a queue change approval process can be based on voting with a timeout. Furthermore, the voters are told what the changes are instead of forcing them to find out or vote blindly. This aspect of the present embodiments is shown in FIG. 20, which is a modification of the process of FIG. 19. The modification is that the calculated differences between the proposed queue and the current on are found 2015 and the voter message data is set to include the calculated differences.

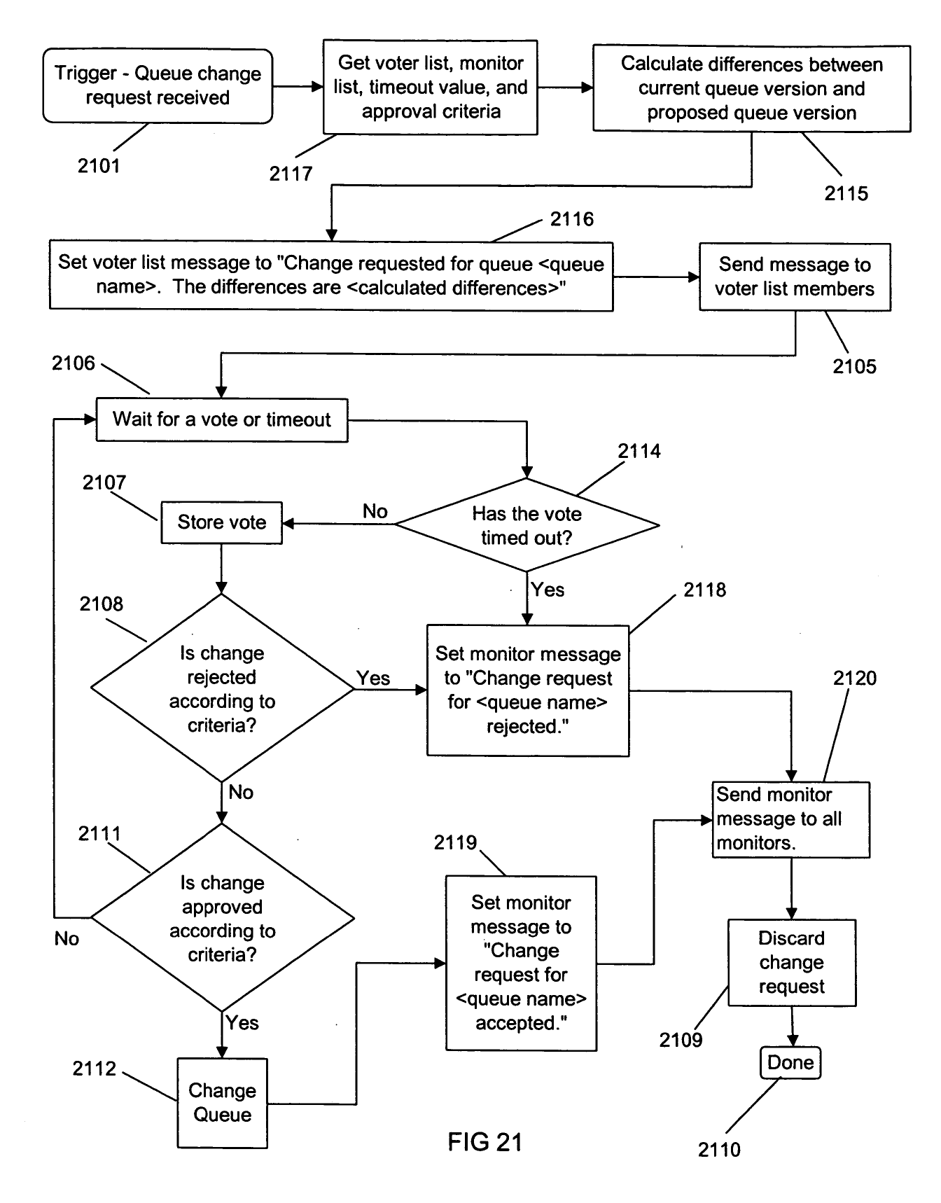

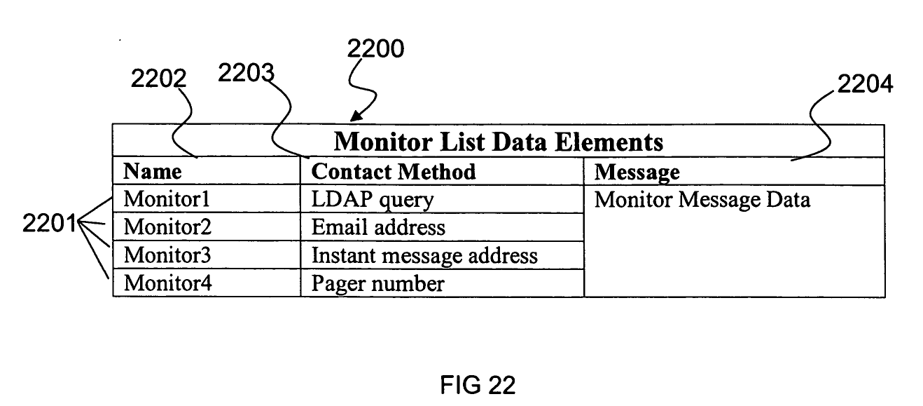

In accordance with another feature of the present embodiments, a queue change approval process can be based on voting with a timeout where the voters are told what the changes are. Furthermore, a group of monitors are told about the outcome of the vote. Before the monitors can be told the vote outcome, their identities must be known. As such, a monitor list 2200 can be an element of a queue 300. The monitor list is similar in use and function to the voter list and subscriber list. This aspect of the present embodiments is shown in FIG. 21, which is a modification of the process of FIG. 20. In the process of FIG. 21, the monitor list 2200 is among the info elements obtained for future use 2117. If the queue change request is approved, the monitor message data is set to indicate approval 2119. If it is rejected, then the monitor message data is set to indicate rejection 2118. In either case, the monitor message data is sent to all monitors 2120 before the change request is discarded 2109 and the process is done 2110.

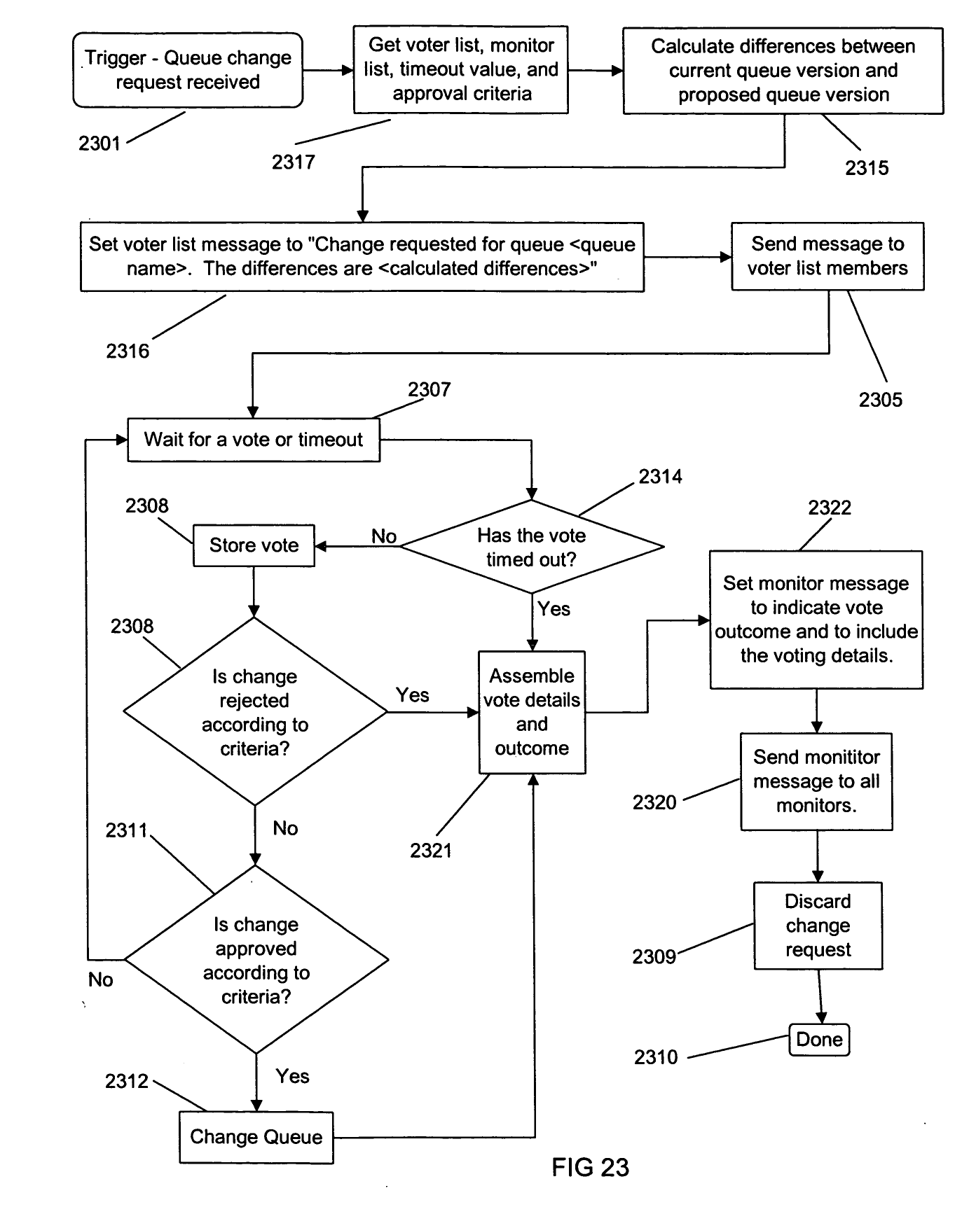

In accordance with another feature of the present embodiments, a queue change approval process can be based on voting with a timeout where the voters are told what the changes are. Furthermore, a group of monitors are told about the outcome of the vote as well as the voting details. Voting details include, but are not limited to, who voted, how they voted, and if the vote timed out. This aspect of the present embodiments is shown in FIG. 23, which is a modification of the process of FIG. 21. In the process of FIG. 23, the vote outcome and details are assembled regardless of if the vote timed out, approved the change, or rejected the change 2321. The monitor message data is set to include the vote outcome and details 2322 and then sent to all monitors 2320. Finally, the change request is discarded 2309 before the process is done 2310.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

The embodiments of the embodiments in which an exclusive property or right is claimed is defined as follows. Having thus described the embodiments, what is claimed is:

1. A method comprising:
associating a subscriber list with a queue; and
alerting all subscribers as soon as the queue configuration is changed.

2. The method of claim 1 further comprising supplying each subscriber with a description of the differences between the original queue configuration and the current queue configuration.

3. The method of claim 2 further comprising recommending to each subscriber other queues that may suit the subscriber's needs.

4. The method of claim 3 further comprising supplying each subscriber with a description of the differences between the original queue configuration and each recommended queue configuration.

5. The method of claim 1 further comprising recommending to each subscriber other queues that may suit the subscriber's needs.

6. The method of claim 1 further comprising supplying each subscriber with a description of the differences between the original queue configuration and each recommended queue configuration.

7. The method of claim 1 further comprising duplicating a queue immediately before it is changed and alerting all subscribers that they can use the duplicate.

8. A method comprising:
associating a subscriber list with a queue; and
tracking each subscriber's knowledge of the queue configuration; and
comparing a subscriber's tracked knowledge to the current queue configuration at the time that the subscriber submits a new job to the queue to find if the subscriber's knowledge is stale; and
alerting a subscriber whose knowledge is found to be stale that the queue configuration has changed.

9. The method of claim 8 further comprising supplying the subscriber with a description of the differences between the known queue configuration and the current queue configuration.

10. The method of claim 9 further comprising recommending to the subscriber other queues that may suit the subscriber's needs.

11. The method of claim 10 further comprising supplying the subscriber with a description of the differences between the original queue configuration and each recommended queue configuration.

12. The method of claim 8 further comprising recommending to the subscriber other queues that may suit the subscriber's needs.

13. The method of claim 8 further comprising supplying the subscriber with a description of the differences between the original queue configuration and each recommended queue configuration.

14. The method of claim 8 further comprising duplicating a queue immediately before it is changed and alerting all subscribers that they can use the duplicate.

15. A method comprising;
associating a voter list with a queue; and
associating an approval criteria with the queue; and
accepting a queue configuration change request; and
alerting each voter of the queue configuration change request; and
accepting votes for and against the queue configuration change request; and
determining when a queue configuration change request has been accepted or rejected; and
changing the queue configuration as required if the queue configuration change request is accepted.
discarding the queue configuration change request if it is rejected.

16. The method of claim 15 further comprising associating a timeout criteria within the approval criteria that automatically rejects a queue configuration change request after a certain amount of time had elapsed.

17. The methods of claims 16 further comprising supplying each voter with a description of the differences between the current queue configuration and what the queue configuration would be if the queue configuration change request is accepted.

18. The method of claim 17 further comprising associating a list of monitors with the queue and alerting each monitor when a queue configuration change request has been accepted or rejected.

19. The method of claim 18 further comprising informing each monitor of the details of the acceptance or rejection of a queue configuration change request.

20. The methods of claims 15 further comprising supplying each voter with a description of the differences between the current queue configuration and what the queue configuration would be if the queue configuration change request is accepted.

21. The method of claim 15 further comprising associating a list of monitors with the queue and alerting each monitor when a queue configuration change request has been accepted or rejected.
